(19) United States
(12) Patent Application Publication
(10) Pub. No.: US 2006/0234702 A1
(43) Pub. Date: Oct. 19, 2006

(54) Selective transmission of mobile radio communications system service information

(75) Inventors: Niclas Wiberg, Linkoping (SE); Magnus S. Persson, Sollentuna (SE)

Correspondence Address: NIXON & VANDERHYE, PC, 901 NORTH GLEBE ROAD, 11TH FLOOR, ARLINGTON, VA, 22203, US

(73) Assignee: TELEFONAKTIEBOLAGET L M ERICSSON (publ), Stockholm (SE)

(21) Appl. No.: 11/108,902

(22) Filed: Apr. 19, 2005

(51) Int. Cl. H04Q 7/20

(52) U.S. Cl. 455/432.3; 455/435.2; 455/432.1

(57) ABSTRACT

A radio base station does not broadcast service information without a request from a mobile radio terminal. When a mobile radio enters or approaches a coverage area of the base station, it transmits a service information request in or near the radio coverage area. The service information is associated with the radio coverage area. When the base station receives the request for service information from the mobile radio, the base station then selectively transmits the service information to the mobile radio, either immediately or after some exchange between the mobile radio and the base station. The service information allows the mobile radio to determine whether the mobile terminal is permitted to obtain service from the radio base station. The base station does not usually broadcast service information in the radio coverage area independently of a request from a mobile radio thereby conserving resources and reducing interference.

### TECHNICAL FIELD

The technical field relates to radio communications systems, and more particularly, to providing system service information to mobile radio terminals from radio base stations.

### BACKGROUND AND SUMMARY

Cellular radio communication systems require that mobile radio stations acquire detailed information about the system before attempting access. “System information” typically identifies the system or network operator and allows the mobile radio to determine if it is allowed to access the network for service. The system information may also include information necessary for the mobile radio to successfully interact with the system, such as channel layout in the frequency, time, or code domain, communications protocol details, etc. System information is typically broadcasted by each radio base station over the geographical coverage area serviced by that base station. By continually transmitting the system information, any mobile station in the coverage area can receive and interpret the information without having to interact with the network. A known pilot signal is usually transmitted along with the system information to help mobile stations in estimating and compensating for distortions caused by the radio channel when reading the system information.

Hereafter, the term “service information” is information transmitted by a base station that allows a mobile radio to determine whether it is permitted to obtain service from and via the base station. The term service information is used here for ease of description and for consistency. Service information may include additional system information.

Broadcasting service information (usually with an associated pilot signal) consumes precious radio transmission resources. In particular, it consumes base station transmission power and creates interference (interference being a resource in the sense that a cell can only function satisfactorily when the interference is below a certain level). Conventional wisdom is that the same service information must be continually or at least very frequently transmitted over the entire cell. Because the service information has to be received in the whole coverage area, even greater transmission power will likely be necessary in sparsely deployed systems. Even if there are no users or only a few users in a certain geographical area, the service information still needs to be broadcast.

There is an ever-increasing demand to provide a variety of applications that require an ever-increasing amount of resources, e.g., multimedia services. The inventors recognized that the significant resources required for such repetitive and sometimes unnecessary service information broadcasting could be more profitably used for transmission of user data. Rather than broadcasting service information, which likely includes an associated pilot, the service information and any pilot are transmitted selectively to an individual mobile terminal only when the mobile terminal makes a request for the service information. This selective transmission of service information, as compared to continual broadcast in the entire cell, frees up significant resources for other more profitable use. In addition, the service information may be transmitted using advanced techniques such as directional antenna beams to further increase the cell coverage and/or decrease the required transmission power.

In a first, non-limiting, example embodiment, a radio base station does not broadcast service information without a request from a mobile radio terminal. When a mobile radio enters or approaches a coverage area of the base station, it transmits a service information request in or near the radio coverage area. The service information is associated with the radio coverage area. When the base station receives the request for service information from the mobile radio, the base station then selectively transmits the service information to the mobile radio. The service information allows the mobile radio to determine whether the mobile terminal is permitted to obtain service from the radio base station. The base station usually does not broadcast service information in the radio coverage area independently from receiving a request from a mobile radio.

In a second, non-limiting, example embodiment, the base station periodically broadcasts an existence signal in the radio coverage area. The existence signal permits the mobile radio to detect the existence of the base station, but it does not include the service information. The broadcast existence signal may be a tone or a predetermined pattern. In response to receiving the base station existence signal, the mobile radio transmits the service information request. As in the first embodiment, when the base station receives the request for service information from the mobile radio, the base station then selectively transmits the service information to the mobile radio.

In a third example embodiment, service information is not transmitted by the base station as an immediate response to the mobile's request for service. Instead, the base station first assigns communication resources, e.g., codes, time slots, frequencies, and/or frequency-hopping patterns, to the mobile radio to permit further two-way communication between the mobile station and the base station. A message is sent to the mobile station identifying the allocated resources for a limited information exchange. Service information may then be revealed to the mobile station in various ways. One example way is for the base station to indicate what type of service(s) it can provide and to what mobile radios. After receiving and analyzing that communication, the mobile radio concludes whether it can obtain the desired service from this base station. Another example way is for the mobile radio to send a further transmission to the base station (in addition to the initial request for service information) indicating what service(s) it wants and its identity (or similar indicator). The base station responds by informing the mobile radio whether it may receive the requested service(s).

A fourth example non-limiting embodiment allows some mobiles to obtain broadcast system information in the traditional way while other mobiles poll for dedicated system information. A benefit of this example embodiment is that, in an area that is not primarily coverage-limited, it may be more efficient (both from a capacity perspective and a delay perspective) to broadcast system information. But in areas with extreme cell ranges that use coverage-extending techniques, it may be preferable to avoid broadcasting system information. Because a mobile usually does not know beforehand what kind of area it is located in, the mobile can be prepared for both situations.

Example service information may include one or more of the following: a pilot signal, information about an operator of the service, information about mobile radios permitted to use the service, an access principle, a channel structure for access to the service, a country code, or a communications protocol. If the mobile can receive service from the base station, a signaling sequence may be initiated to set up some type of user connection between the base station and the mobile radio or perform some service for the mobile radio.

In one non-limiting, example implementation, the base station receives the service information request on a same frequency as the broadcast existence signal but during a different time interval or using a different code. Alternatively, the base station receives the service information request on a different frequency from the broadcast existence signal. Preferably, the base station uses the received service information request to estimate the direction of the mobile radio, and then transmits the service information back in the same direction using a narrow or directional antenna beam directed towards the mobile radio. This directed transmission of service information is a much more efficient use of transmission resources and substantially reduces unnecessary interference in other parts of the cell.

### BRIEF DESCRIPTION OF THE DRAWINGS

FIG. 1 illustrates a conventional cellular communications system where base stations coupled to different cellular networks broadcast service information over their entire, respective cell areas on a continual basis;

FIG. 2 is a graph illustrating cell throughput and cell power as a function of cell radius for a cell in a conventional cellular system like that shown in FIG. 1;

FIG. 3 illustrates a first, non-limiting, example embodiment of a cellular communications system where base stations coupled to different cellular networks selectively transmit service information to mobile radios that request it;

FIG. 4 is a flow chart diagram illustrating example steps for selectively transmitting service information in response to a mobile radio request in accordance with the first example embodiment;

FIG. 5 illustrates a second, non-limiting, example embodiment of a cellular communications system where base stations broadcast a simple existence signal that does not contain service information and selectively transmit service information to mobile radios that request it;

FIG. 6 is a graph of base station transmission power against time useful in illustrating one example of broadcasting a base station existence signal;

FIGS. 7A and 7B graph base station transmission power and mobile station transmission power against time and illustrate an example of broadcasting a base station existence signal followed by a mobile station request signal;

FIG. 8 is a flow chart diagram illustrating example steps for selectively transmitting service information in response to a mobile radio request in accordance with the second example embodiment;

FIG. 9 is a graph illustrating cell throughput and cell power as a function of cell radius for a cell in a cellular system having selective transmission of service information to mobile radio;

FIG. 10 is a simplified function block diagram of a base station; and

FIG. 11 is a simplified function block diagram of a mobile station.

### DETAILED DESCRIPTION

In the following description, for purposes of explanation and non-limitation, specific details are set forth, such as particular nodes, functional entities, techniques, protocols, standards, etc. in order to provide an understanding of the described technology. It will apparent to one skilled in the art that other embodiments may be practiced apart from the specific details disclosed below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs).

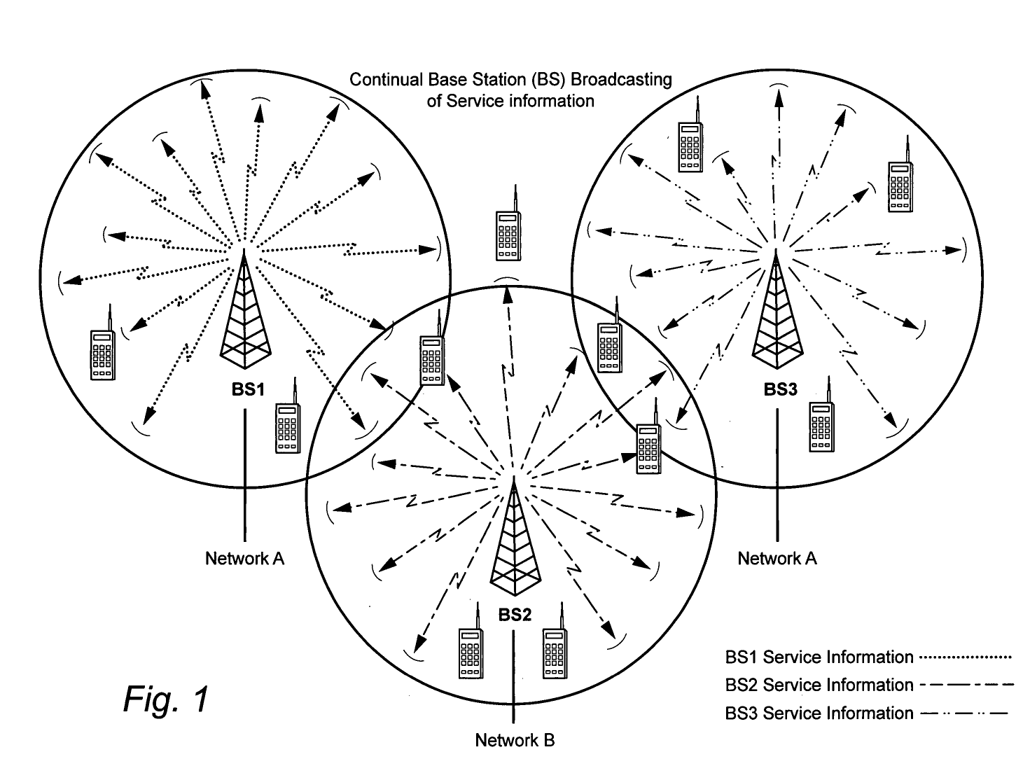

FIG. 1 illustrates a conventional cellular radio communications system that supports wireless communications. This system may accommodate one or more standard architectures including but not limited to a universal mobile telecommunications system (UMTS) based on code division multiple access (CDMA), GSM/GPRS/EDGE and other systems based on time division multiple access (TDMA), frequency division multiple access (FDMA) systems, orthogonal frequency division multiple access (OFDM) systems, etc. Each of the three cell coverage area represented in the figure as a circle is associated with a corresponding radio base station BS1, BS2, and BS3. Two of the base stations, BS1 and BS3, belong to the same cellular network operator A. The other base station BS2 belongs to a different cellular network operator B.

Each base station BS broadcasts continuously or very frequently on a known broadcast channel service information that is specific to that base station, (e.g., base station identifier, broadcast channel frequency or other identifier, pilot signal, access channel frequency or other identifier, etc.) and service information that is specific to the base station's network operator, (e.g., network type, network identifier, information that indicates whether a mobile radio may obtain service from this base station, access principles and channel structures to govern continued access to that particular operator's network, protocol version, protocol timers, paging period, paging area information, cell identity, neighbor cell information, cell access restriction, information for different channels like paging, random access, resource assignment, and data channels, transmission power, time slot, frequency of a frequency hopping pattern, spreading code, positioning information, timing information, etc.). As the arrows represent, that system information is transmit continually over the entire cell coverage for the base station, regardless of whether mobile radios are located in the cell or even if there are any mobile radios currently in the cell. Each base station's arrows are different to represent the different service information being broadcast, even from base stations belonging to the same cellular network.

Mobile radios (sometimes also referred to as mobile stations, mobile terminals, wireless terminals, wireless devices, user equipment, etc.) desiring to receive cellular service listen or “scan” for broadcast channels. In that process, the mobile radio finds the broadcast channel of the base station in whose cell area the mobile radio is currently located and detects the service information being broadcast. Based on that information, the mobile radio determines whether it is allowed to request service from this base station or whether it must search elsewhere for service. If the mobile is permitted to make access, it may then initiate further signaling with the base station using access information included in the service information to obtain service.

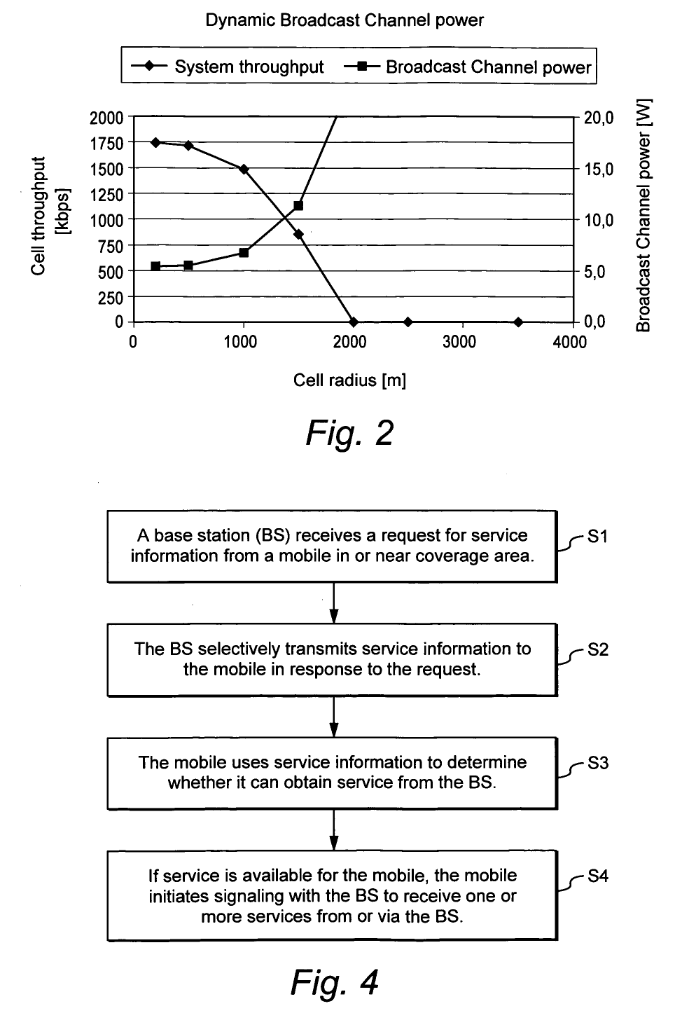

The capacity of conventional systems is limited by the significant cellular communications resources (e.g., power) required for base station broadcast of service information. This limitation is particularly evident in unloaded cells where the number of mobiles is lower than normal. This problem in this situation is illustrated in FIG. 2 which graphs cell throughput in kbps and broadcast channel transmission power in watts (W) against cell range in meters (m). For the first 750 m, the cell throughput (1750 kbps) and broadcast power (less than 6 W) are relatively constant. But after 1000 m, the broadcast power increases at a steep slope to 20 W at less than 2000 m, four times what it was at 750 m. Given the steep slop, the 2000 m is the end of the cell because the base station does not have enough power to reach mobile radios further than 2000 m. After 750 m, the cell throughput decreases at a steep slope to 0 kbps (no throughput), at 2000 m. In addition to preserving more communications resources for user data, it would be desirable to avoid this significant cell coverage limitation and throughput drop for large cells.

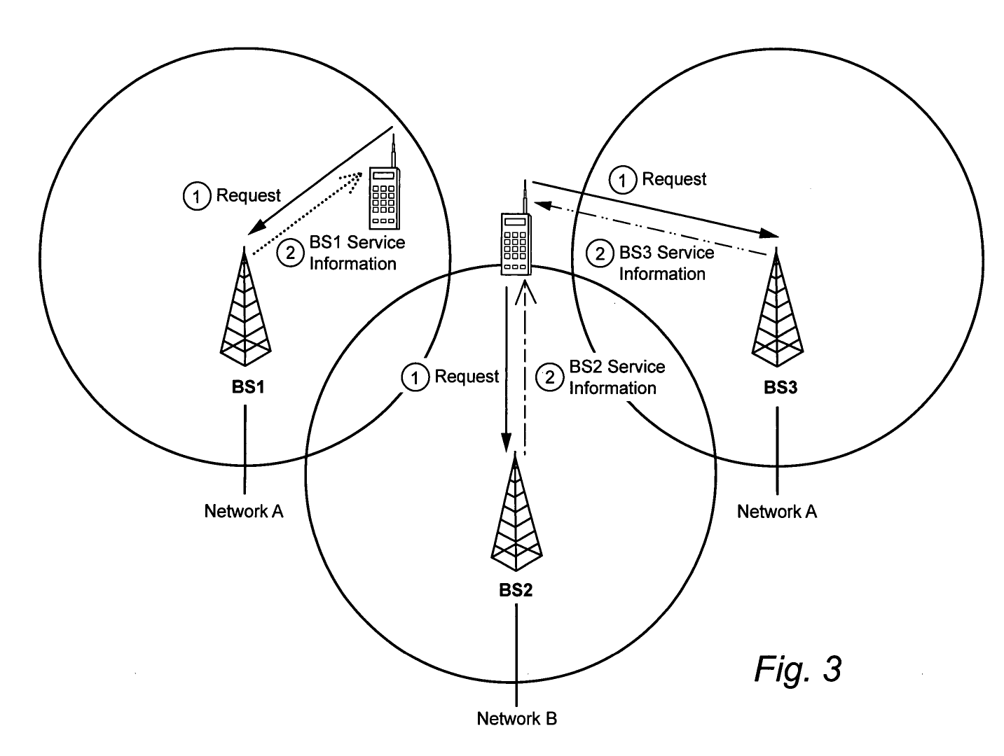

FIG. 3 illustrates a first, non-limiting, example embodiment of a cellular radio communications system that supports wireless communications similar to what is shown in FIG. 1 but without traditional base station broadcasting of service information. Instead, the base stations selectively transmit service information to specific mobile radios. Namely, when a mobile radio transmits a request for service information, a base station receiving that request responds by transmitting its service information to that mobile radio. For example, a mobile radio sends a request message shown as (1), and base station BS 1 receives the request and responds with a transmission (2) to the mobile radio with the BS1 service information. The other base stations are shown in similar situations with each responding with its particular service information.

FIG. 4 illustrates example steps that may be carried out for the first example embodiment. A base station (BS) receives a request for service information from a mobile in or near a coverage area associated with the base station (step S1). The base station selectively transmits service information to the mobile in response to the request (step S2). The mobile radio analyzes service information to determine whether it can obtain service from the base station (step S3). If service is available for the mobile radio, the mobile radio initiates signaling with the base station to receive one or more services from or via the base station (step S4).

In effect, the mobile radio is “polling” nearby base stations for service information, and each base station is “listening” or configured to receive such polling requests. The mobile radios may poll nearby base stations by sending the simple request signal over each of a list of base station access channels, or it may simply scan through a frequency band, time slot range, code tree, etc. The service information may include any type of information associated with the base station, the cellular network operator, access, services, protocols, parameters, etc. that may be necessary or useful in determining if access to service is available and what services are available, initiating access, and obtaining service. Several examples of service information were described above in the description of FIG. 1. In this way, each base station BS avoids having to broadcast continuously or very frequently on a known broadcast channel such service information so that it is only transmit when needed. This dramatic reduction in transmission traffic associated with mobile radios receiving service information is readily apparent when comparing FIGS. 1 and 3.

Mobile radios (sometimes also referred to as mobile stations, mobile terminals, wireless terminals, wireless devices, user equipment, etc.) desiring to receive cellular service listen or “scan” for broadcast channels. In that process, the mobile finds the broadcast channel of the base station in whose cell area the mobile radio is currently located (or an adjacent base station) and detects the service information being broadcast. Based on that information, the mobile radio determines whether it is allowed to request service from this base station or search elsewhere for service. If the mobile is permitted to make access, it may then initiate further signaling with the base station using access information included in the service information to obtain service.

Although the first embodiment is very resource efficient, various factors including governmental or other regulations may require that the base stations transmit some sort of minimal base station existence signal on a periodic basis. This base station existence signal could be a short fixed pattern signal that is transmitted periodically, i.e., time shared with other signals transmitted from the same BS. The fixed pattern does not convey any information other than to signal the presence of the base station. In other words, it does not contain “service information” in the usual sense and as defined above. Being a fixed pattern, the base station existence signal is relatively simple to detect even with a low received energy. In other words, the base station existence signal can be rather short and still be detected even far away from the base station.

It may be desirable to use a few different patterns. This may not be necessary if neighboring base station existence signals are sufficiently time-shifted relative to each other. For instance, four simple patterns might be used to distinguish between neighboring base stations. But having multiple patterns requires a longer signal, which uses more transmitted energy.

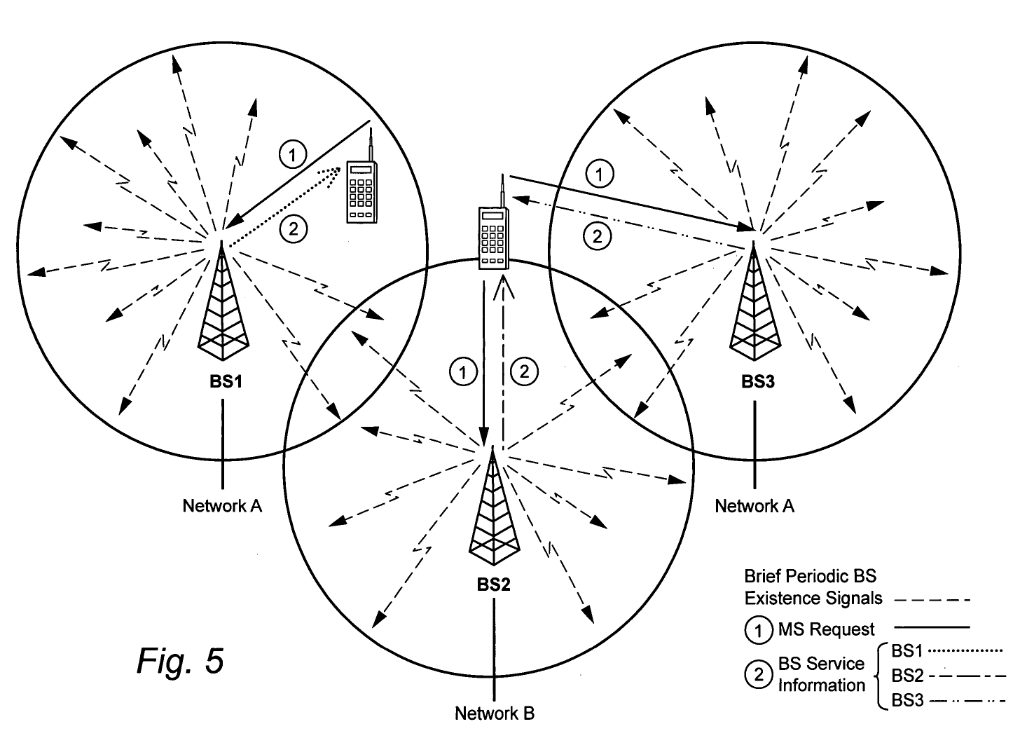

FIG. 5 illustrates a second, non-limiting, example embodiment of a cellular radio communications system that supports wireless communications similar to what is shown in FIG. 1 but without traditional base station broadcasting of service information. As with the first example embodiment, the base stations selectively transmit service information to specific mobile radio requests. But in addition, the base stations broadcast a simple base station existence signal to let mobile radios receiving that signal know that it is there and the frequency over which to transmit the request signal. Once the mobile detects the frequency of the broadcast base station existence signal, the mobile radio may either transmit the request on the same frequency at a different time between broadcasts, or at a predetermined frequency or channel offset.

As shown FIG. 5, periodic base station existence signals (shown as dashed lines) are transmitted over the cell area. Having detected the base station existence signal in a cell area, the mobile radio sends a request message shown as (1), and base station BS1 receives the request and responds with a transmission (2) to the mobile radio with the BS1 service information. The other base stations are shown in similar situations but each responds with its own service information. The base station existence signal preferably does not include any service information.

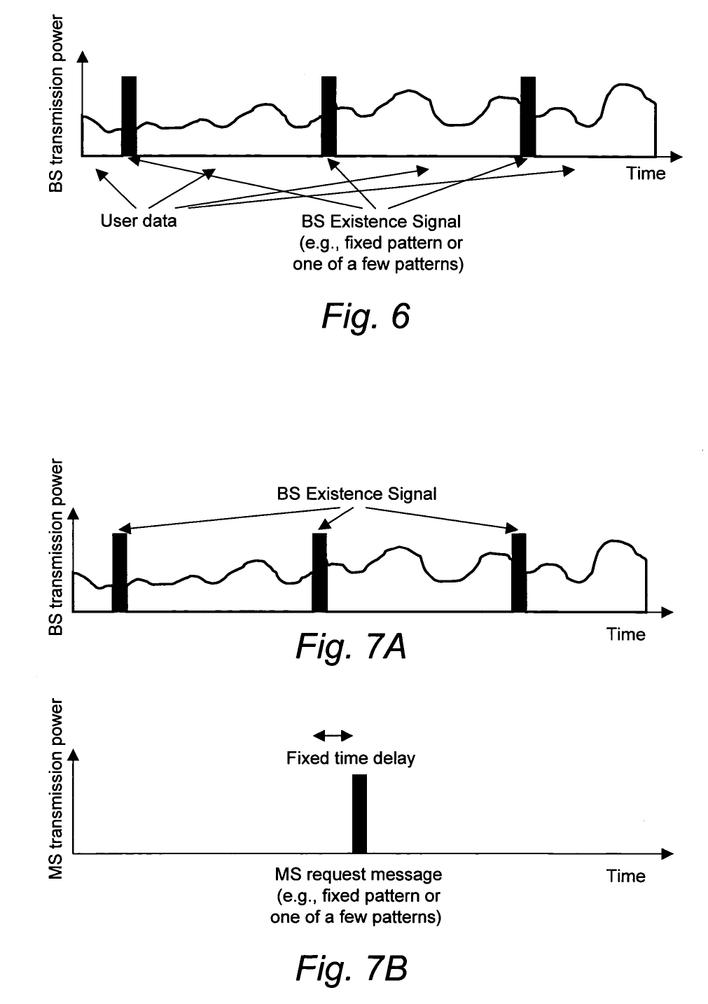

FIG. 6 shows broadcast of a base station existence signal and transmission of user data using time division. The lengths of the base station existence signal and user data periods are not drawn to scale. The base station existence signal is preferably long enough to be reliably detectable by a mobile radio even under relatively challenging radio conditions, e.g. far away from the base station. However, a too-long period will consume more transmission resources, and therefore, a balance is preferably made. FIGS. 7A and 7B shows the mobile radio request message being transmitted a fixed time delay after the base station existence message. In this example, the mobile radio only transmits a request message when it has reliably detected a base station existence signal. Further constraints may apply. For instance, the mobile radio may receive a response message that effectively forbids it to transmit further requests within a certain time period. Such restrictions may apply within a particular frequency band or in general.

In its simplest form, the MS request signal could also be a fixed pattern, transmitted at a fixed time offset relative to the simple broadcast message. Preferably, no other transmissions should occur simultaneously (on the same frequency), at least not from other mobile radios connected to the same base station. This avoids interference to increase the chance of the request being detected by the base station.

Again, using a fixed pattern increases the chances of detecting even a pattern with a low received energy (a short pattern). However, it may be desirable to have a few different request patterns in order to distinguish between multiple mobile radios transmitting their requests simultaneously. Each mobile radio would then choose one of the available patterns, (e.g., randomly), and the base station would identify which pattern it detected in its response message.

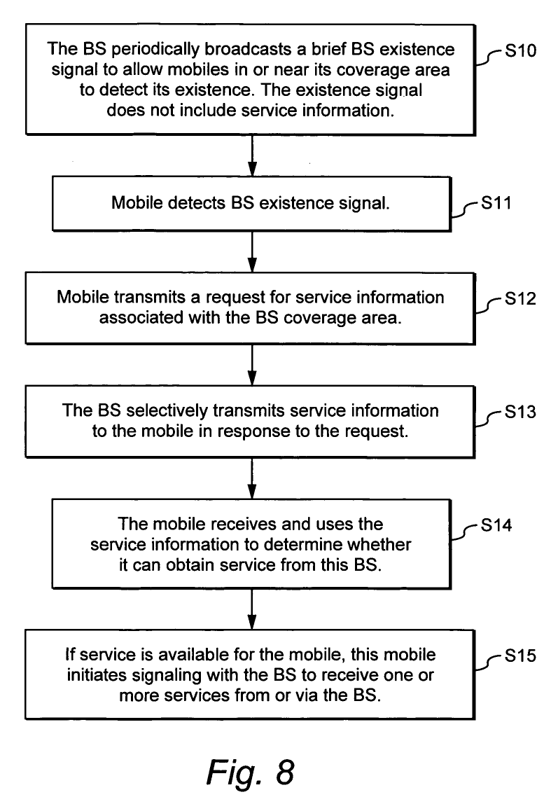

FIG. 8 illustrates example steps that may be carried out for the second example embodiment. A base station (BS) periodically broadcasts a brief BS existence signal to allow mobile radios in or near it coverage area to detect its existence (step S10). The BS existence signal preferably does not include service information. The mobile radio detects the BS existence signal (step S11). The mobile radio transmits a request for service information associated with the BS coverage area (step S12). The base station receives the request for service information from the mobile radio and selectively transmits service information to the mobile in response to the request (step S13). The mobile radio receives and uses the service information to determine whether it can obtain service from the base station (step S14). If service is available for the mobile radio, the mobile radio initiates signaling with the base station to receive one or more services from or via the base station (step S15).

The base station should listen for request messages at each possible occurrence. A base station may use directional antennas to increase the chances of detecting requests while at the same time determining the direction of the requesting mobile radio. One example technique is to form a number of fixed reception beams and try to detect requests within each beam. Each beam amplifies signals transmitted from mobile radios with a certain direction. When the base station detects a request, it should transmit a response message to the mobile station, possibly initiating a signaling sequence that may lead to a service, e.g., registration, call setup, etc. A base station with directional antennas may use direction information for the mobile radio that was gathered when detecting the initial request to direct the transmission of the response message back to the mobile radio, thereby substantially reducing the required transmission power.

The description above is based on time division, both between simple broadcast message and other signals from the BS (including service information), and between the ervice information request message and other signals from mobile radios. Other multiplexing and multiple-access techniques may be used, such as frequency division, possibly with frequency hopping, code division, or combinations thereof. A combination of time and frequency division could be particularly advantageous for the request message, since a single mobile radio may not be able to efficiently utilize the entire spectrum.

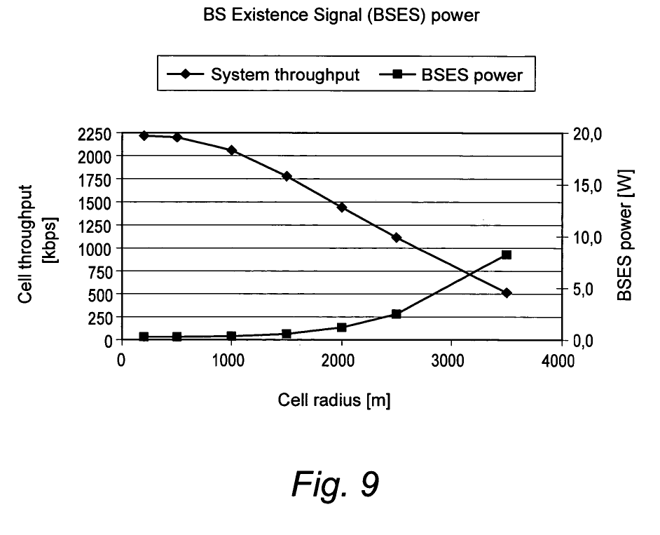

Advantages of selective transmission of service information by base stations in accordance with the second example embodiment, as compared to traditional service information broadcast, is illustrated by comparing the graph in FIG. 9 with that in FIG. 2. FIG. 9 also plots cell throughput in kbps and broadcast channel transmission power in watts (W) against cell range in meters (m). Significantly, absolute gains are achieved in both cell throughput and the transmit power required to broadcast the base station existence signal (BSES). The cell throughput starts at 2250 kbps and stays above 2000 kbps for the first 1000 m as compared to 1750 kbps in FIG. 2. From 1000-3500 m, the cell throughput decreases at a relatively gradual slope from 2000 kbps to 500 kbps. In FIG. 2, the cell throughput is zero for 2000 m and more. The base station broadcast power is nearly zero for the first 1500 m as compared to 6 W or more in FIG. 2. Between 1500-2500 m, the broadcast power increases at a gradual slope to 2 W, and a somewhat steeper slope from 2500-3500 m to about 8 W. Recall that in the traditional system in FIG. 2, the broadcast signal could not even extend beyond about 2000 m. Thus, significant improvement is obtained in cell throughput and broadcast power. Moreover, the coverage and performance in larger cells is dramatically improved. Even greater improvements may be obtained using the first embodiment that does not use a BSES.

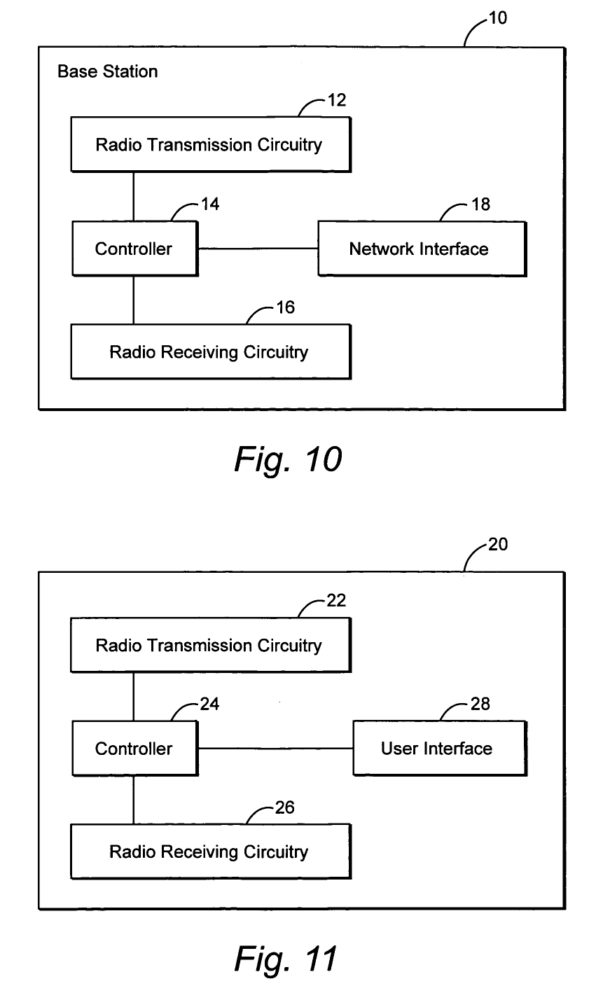

Simplified function block diagrams are shown in FIGS. 10 and 11 for implementing the selective service information transmission features. FIG. 10 shows a base station 10 that includes radio transmission circuitry 12 and radio receiving circuitry 16 coupled to a controller 14. The controller 14 is also coupled to a network interface 18 for communication with the rest of the radio network. This circuitry is configured to perform the functions described above for the mobile radio.

FIG. 11 shows a mobile radio 20 that includes radio transmission circuitry 22 and radio receiving circuitry 26 coupled to a controller 24. The controller 14 is also coupled to a user interface 28 (coupled to a speaker, microphone, keypad, touchpad, or display, etc.) for communication with a user. This circuitry is configured to perform the functions described above for the base station.

In a third example embodiment, service information is not transmitted as an immediate response to the mobile's request for service. Instead, the base station first assigns communication resources, e.g., codes, time slots, frequencies, and/or frequency-hopping patterns, to the mobile radio to permit further two-way communication between the mobile station and the base station. A message is sent to the mobile station identifying the allocated resources for a limited information exchange. Service information may then be revealed to the mobile station in various ways. One example way is for the base station to indicate what type of service(s) it can provide and to what mobile radios. After receiving and analyzing that communication, the mobile radio concludes whether it can obtain the desired service from this base station. Another example way is for the mobile radio to send a further transmission to the base station (in addition to the initial request for service information) indicating what service(s) it wants and its identity (or similar indicator). The base station responds by informing the mobile radio whether it may receive the requested service(s).

A fourth example non-limiting embodiment allows some mobiles to obtain broadcast system information while other mobiles poll for dedicated system information. As described above, all mobiles either first search for broadcast system information or a base station existence signal. In the latter case, when a mobile finds such a signal, it searches for broadcast system information in the traditional way. If the broadcast information is found by the mobile, it proceeds in the traditional way, e.g., reading and interpreting the system information, taking appropriate actions such as attempting access or not, etc. If the mobile does not detect traditional broadcast system information, it sends a request for system information, for example, as described above. A benefit of this example embodiment is that, in an area that is not primarily coverage-limited, it may be more efficient (both from a capacity perspective and a delay perspective) to broadcast system information. But in areas with extreme cell ranges that use coverage-extending techniques, it may be preferable to avoid broadcasting system information. Because a mobile usually does not know beforehand what kind of area it is located in, the mobile can be prepared for both situations.

Although various embodiments have been shown and described in detail, the claims are not limited to any particular embodiment or example. None of the above description should be read as implying that any particular element, step, range, or function is essential such that it must be included in the claims scope. The scope of patented subject matter is defined only by the claims. The extent of legal protection is defined by the words recited in the allowed claims and their equivalents. No claim is intended to invoke paragraph 6 of 35 USC §112 unless the words “means for” are used.

1. A method, for use in a radio base station, for communicating mobile radio communications service information in a radio coverage area, comprising:
(a) receiving a request for service information associated with the radio coverage area from a mobile radio in or near the radio coverage area, and
(b) selectively transmitting the service information to the mobile radio in response to receiving the request,
wherein the service information allows the mobile radio to determine whether the mobile terminal is permitted to obtain service from the radio base station.

2. The method in claim 1, wherein the base station does not broadcast service information in the radio coverage area independently of a request from a mobile radio.

3. The method in claim 2, wherein the base station only transmits the service information when the request is received by the base station.

4. The method in claim 1, wherein the base station generally broadcasts the service information in the radio coverage area and also specifically transmits the service information in response to receiving the request.

5. The method in claim 1, wherein before (a) the method further comprises:
periodically broadcasting in the radio coverage area an existence signal sufficient for the mobile radio to detect the existence of the base station, wherein the existence signal does not include the service information transmitted in (b).

6. The method in claim 5, wherein the base station receives the request on a same frequency as the broadcast existence signal but during a different time interval or the base station receives the request on a different frequency from the broadcast existence signal.

7. The method in claim 5, wherein the broadcast existence signal is a tone or a predetermined pattern.

8. The method in claim 1, wherein the service information includes one or more of the following: a pilot signal, information about an operator of the service, information about mobile radios permitted to use the service, an access principle, a channel structure for access to the service, a country code, or a communications protocol.

9. The method in claim 1, wherein base station transmits the service information to the mobile radio using a narrow or directional antenna beam directed towards the mobile radio or the base station receives the request using one or more directional antennas.

10. The method in claim 1, wherein after receiving the request, the base station allocates communication resources to permit two communication between the base station and the mobile radio and uses the allocated resources to indicate what type of service the base station can provide and to what mobile radios.

11. The method in claim 1, wherein after receiving the request, the base station allocates communication resources to permit two communication between the base station and the mobile radio, and the mobile radio then uses the allocated resources to indicate to the base station a desired service.

12. The method in claim 1, further comprising:
in response to the request, initiating a signaling sequence leading to setting up a user connection between the base station and the mobile radio to perform a service for the mobile radio.

13. A mobile radio for communicating with a radio base station servicing a radio coverage area, comprising:
radio transmitting circuitry for transmitting in or near the radio coverage area a service information request, the service information being associated with the radio coverage area;
radio receiving circuitry for receiving a information from the radio base station in response to the request; and
electronic control circuitry, coupled to the radio transmitter and to the radio receiver, configured to initiate further communications with the radio base station or not based on the received information.

14. The mobile radio in claim 13, further comprising:
prior to transmitting the service information request, the receiver is configured to detect a base station existence signal transmitted by the base station that does not include the requested service information associated with the radio coverage area,
wherein the electronic control circuitry is configured to control the radio transmission circuitry to transmit the service information request based on the base station existence signal.

15. The mobile radio in claim 14, wherein the electronic control circuitry is configured to request the service information when generally broadcast service information in the radio coverage area is not received.

16. The mobile radio in claim 13, wherein the service information includes one or more of the following: a pilot signal, information about an operator of the service, information about mobile radios permitted to use the service, an access principle, a channel structure for access to the service, a country code, or a communications protocol.

17. The mobile radio in claim 13, wherein the radio transmission circuitry is configured to transmit the service information request without having to receive any information transmit from the radio base station.

18. The mobile radio in claim 13, wherein the radio transmission circuitry is configured to transmit the service information request without having to receive a signal transmit from the radio base station.

19. The mobile radio in claim 13, wherein the service information request includes a fixed pattern or one of a group of fixed patterns.

20. The mobile radio in claim 13, wherein the radio receiving circuitry is configured to receive from the base station an identification of resources allocated by the base station to permit communication between the mobile radio and the base station, and wherein the electronic control circuitry and radio transmitting circuitry are configured to use the allocated resources to indicate to the base station a desired service.

21. Apparatus in a radio base station for communicating mobile radio communications service information in a radio coverage area, comprising:
receiving circuitry for receiving a request for service information associated with the radio coverage area from a mobile radio in or near the radio coverage area;
transmitting circuitry for selectively transmitting the service information to the mobile radio in response to the request,
wherein the service information allows the mobile radio to determine whether the mobile terminal is permitted to obtain service from the radio base station.

22. The apparatus in claim 21, wherein the transmitting circuitry is configured to not broadcast service information in the radio coverage area independently of a request from a mobile radio.

23. The apparatus in claim 21, wherein the transmitting circuitry is configured to only transmit the service information when the request is received by the base station.

24. The apparatus in claim 21, wherein the transmitting circuitry is configured to generally broadcast the service information in the radio coverage area and also specifically transmit the service information in response to receiving the request.

25. The apparatus in claim 21, wherein the transmitting circuitry is configured to periodically broadcast in the radio coverage area an existence signal sufficient for the mobile radio to detect the existence of the base station, wherein the existence signal does not include the service information.

26. The apparatus in claim 25, wherein the receiving circuitry is configured to receive the request on a same frequency as the broadcast existence signal but during a different time interval or to receive the request on a different frequency from the broadcast existence signal.

27. The apparatus in claim 25, wherein the broadcast existence signal is a tone or a predetermined pattern.

28. The apparatus in claim 25, wherein the service information includes one or more of the following: a pilot signal, information about an operator of the service, information about mobile radios permitted to use the service, an access principle, a channel structure for access to the service, a country code, or a communications protocol.

29. The apparatus in claim 21, wherein the transmitting circuitry is configured to transmit the service information to the mobile radio using a narrow or directional antenna beam directed towards the mobile radio.

30. The apparatus in claim 21, wherein the receiving circuitry is configured to receive the request using one or more directional antennas.

31. The apparatus in claim 21, wherein the transmitting circuitry is configured to initiate a signaling sequence, in response to the request, leading to setting up a user connection between the base station and the mobile radio to perform a service for the mobile radio.

32. The apparatus in claim 21, wherein the base station includes a controller for allocating communication resources after receiving the request to permit two way communication between the base station and the mobile radio and for using the allocated resources to indicate to the mobile radio what type of service the base station can provide and to what mobile radios.

33. The apparatus in claim 21, wherein the base station includes a controller for allocating communication resources after receiving the request to permit two way communication between the base station and the mobile radio, and the receiving circuitry is configured to receive from the mobile radio via the allocated resources an indication of a desired service.
